(19) United States
(12) Patent Application Publication
(10) Pub. No.: US 2026/0162340 A1
(43) Pub. Date: Jun. 11, 2026

(54) METHOD, APPARATUS, DEVICE AND STORAGE MEDIUM FOR MUSIC VIDEO GENERATION

(71) Applicant: Beijing Zitiao Network Technology Co., Ltd., Beijing (CN)

(72) Inventors: Xiaomin LU, Beijing (CN); Yong YOU, Beijing (CN); Linwei LI, Beijing (CN); Yiming SONG, Beijing (CN)

(21) Appl. No.: 19/363,346

(22) Filed: Oct. 20, 2025

(30) Foreign Application Priority Data
Dec. 6, 2024 (CN) 202411799240.2

(51) Int. Cl. G06T 13/00; G06T 11/00

(52) U.S. Cl. CPC G06T 13/00; G06T 11/00

(57) ABSTRACT

According to embodiments of the disclosure, a method, an apparatus, a device, and a computer-readable storage medium for music video generation are provided. The method includes: obtaining a generation request, the generation request being associated with reference music; and providing a music video generated based on the generation request, where the music video is generated based on a video template and a set of images, the video template is determined based on an audio feature of the reference music, and the set of images is generated based on description information of the reference music.

### CROSS-REFERENCE

The present application claims priority to Chinese Patent Application No. 202411799240.2, filed on Dec. 6, 2024, and entitled “METHOD, APPARATUS, DEVICE AND STORAGE MEDIUM FOR MUSIC VIDEO GENERATION”, which is incorporated herein by reference in its entirety.

### FIELD

Example embodiments of the present disclosure generally relate to the field of computers, and in particular, to a method, an apparatus, a device, and a computer-readable storage medium for music video generation.

### BACKGROUND

With the development of computer technologies, more and more users share music on video platforms. For example, users may produce music content into video content and post the video content to video platforms. Some video platforms also provide users with a function of automatically generating music videos to facilitate users to produce video content.

### SUMMARY

In a first aspect of the present disclosure, a method for music video generation is provided. The method includes: obtaining a generation request, the generation request being associated with reference music; and providing a music video generated based on the generation request, where the music video is generated based on a video template and a set of images, the video template is determined based on an audio feature of the reference music, and the set of images is generated based on description information of the reference music.

In a second aspect of the present disclosure, an apparatus for music video generation is provided. The apparatus includes: an obtaining module configured to obtain a generation request, the generation request being associated with reference music; and a provision module configured to provide a music video generated based on the generation request, where the music video is generated based on a video template and a set of images, the video template is determined based on an audio feature of the reference music, and the set of images is generated based on description information of the reference music.

In a third aspect of the present disclosure, an electronic device is provided. The device includes at least one processor; and at least one memory, the at least one memory being coupled to the at least one processor and storing instructions executable by the at least one processor. The instructions, when executed by the at least one processor, cause the device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It should be understood that content described in this content part is neither intended to limit key or essential features of embodiments of the present disclosure, nor is used to limit the scope of the present disclosure. Other features of the present disclosure will become readily comprehensible through the following description.

### BRIEF DESCRIPTION OF THE DRAWINGS

The above and other features, advantages, and aspects of embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments according to the present disclosure may be implemented;

FIG. 2A to FIG. 2B show example interfaces according to some embodiments of the present disclosure;

FIG. 3 shows an example block diagram of a method for music video generation according to some embodiments of the present disclosure;

FIG. 4 shows a flowchart of an example process of music video generation according to some embodiments of the present disclosure;

FIG. 5 shows a schematic structural block diagram of an example apparatus for music video generation according to some embodiments of the present disclosure; and

FIG. 6 shows a block diagram of an electronic device capable of implementing multiple embodiments of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes and are not intended to limit the protection scope of the present disclosure.

It should be noted that the titles of any section/sub-section provided herein are not restrictive. Various embodiments are described throughout this article, and any type of embodiment may be included under any section/sub-section. In addition, the embodiments described in any section/sub-section may be combined in any way with any other embodiments described in the same section/sub-section and/or different section/sub-section.

In the description of the embodiments of the present disclosure, the term “include/comprise” and its similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. The following may also include other explicit and implicit definitions. The terms “first”, “second”, etc. may refer to different or same objects. The following may also include other explicit and implicit definitions.

Embodiments of the present disclosure may involve user data, data acquisition and/or data use, etc. These aspects all comply with corresponding laws, regulations and related provisions. In embodiments of the present disclosure, all the collection, acquisition, processing, machining, forwarding, use of data, etc. are carried out on the premise that the user is aware and confirms. Accordingly, when implementing various embodiments of the present disclosure, the user should be informed of the type, use range, use scenario, etc., of possible involved data or information and the authorization of the user should be obtained in an appropriate manner according to relevant laws and regulations. The specific manner of informing and/or authorizing may be changed according to actual situations and application scenarios, and the scope of the present disclosure is not limited in this regard.

If the solutions in this specification and embodiments involve personal information processing, the processing will be carried out on the premise that there is a legal basis (for example, the consent of the personal information subject is obtained, or it is necessary to perform a contract, etc.), and the processing will only be carried out within the scope of provisions or agreements. If a user refuses to process personal information other than necessary information required for basic functions, it will not affect the use of the basic functions by the user.

As mentioned above, with the development of computer technologies, more and more users share music on video platforms. Users may, for example, produce music content into video content and post the video content to video platforms. Some video platforms also provide users with a function of automatically generating music videos to facilitate users to produce video content. However, the music videos generated by the traditional automatic generation function of music videos have a poor fit with music, poor dynamic effects and monotonous content. As a result, the automatically generated music videos are difficult to meet the needs of users.

Embodiments of the present disclosure provide a solution for music video generation. The solution includes: obtaining a generation request, the generation request being associated with reference music; and providing a music video generated based on the generation request, where the music video is generated based on a video template and a set of images, the video template is determined based on an audio feature of the reference music, and the set of images is generated based on description information of the reference music.

In this way, by generating a music video based on an audio feature of music and a video template, embodiments of the present disclosure are capable of efficiently generating music videos based on features of music and video templates, thereby improving the efficiency of music video generation, increasing the fit between music videos and music, and enriching the content of music videos.

Various example implementations of the solution are described in detail below in further conjunction with the drawings.

### Example Environment

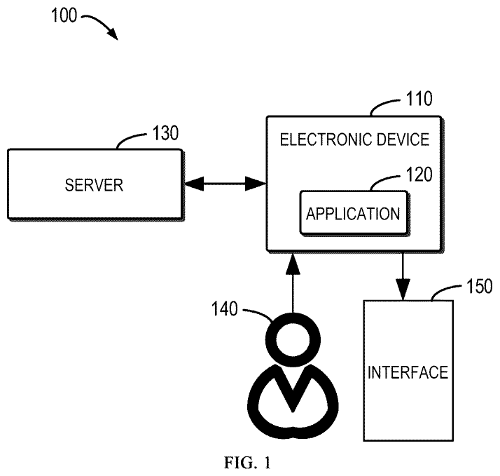

FIG. 1 shows a schematic diagram of an example environment 100 in which the embodiments of the present disclosure may be implemented. As shown in FIG. 1, the example environment 100 may include an electronic device 110.

In the example environment 100, the electronic device 110 may run an application 120 supporting music video generation. The application 120 may be any appropriate type of application for music video generation, examples of which may include, but are not limited to, video applications, live streaming applications, or other appropriate applications capable of providing music video generation services. A user 140 may interact with the application 120 via the electronic device 110 and/or its attached device.

In the environment 100 of FIG. 1, if the application 120 is active, the electronic device 110 may present an interface 150 for supporting music video generation through the application 120.

In some embodiments, the electronic device 110 communicates with a server 130 to implement provision of services of the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination of the foregoing, including fittings and peripherals of these devices or any combination thereof. In some embodiments, the electronic device 110 may also support any type of user-specific interface (such as “wearable” circuitry, etc.).

The server 130 may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide backstage services for the application 120 supporting music video generation in the electronic device 110.

A communication connection may be established between the server 130 and the electronic device 110. The communication connection may be established by a wired or wireless method. The communication connection may include, but is not limited to, a Bluetooth connection, a mobile network connection, a universal serial bus (USB) connection, a wireless fidelity (WiFi) connection, etc., and embodiments of the present disclosure are not limited in this regard. In embodiments of the present disclosure, the server 130 and the electronic device 110 may implement signaling interaction through the communication connection therebetween.

It should be understood that the structure and function of each element in the environment 100 are described for illustrative purposes only, without implying any limitation on the scope of the present disclosure.

Some example embodiments of the present disclosure are described below with continued reference to the drawings.

### Example Interaction

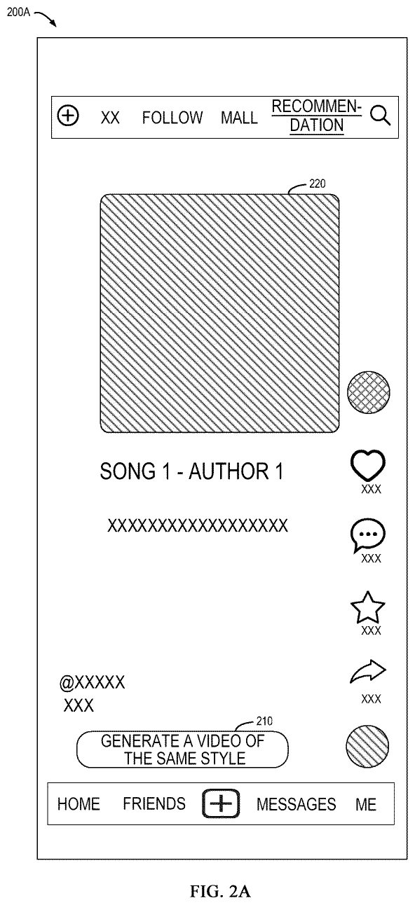

FIG. 2A to FIG. 2B show example interfaces 200A to 200B according to some embodiments of the present disclosure. For example, the interfaces 200A to 200B may be provided by the electronic device 110 shown in FIG. 1.

The interfaces 200A to 200B may be interfaces for consuming video content in a video application.

Referring to FIG. 2A, in some embodiments, the electronic device 110 may present the interface 200A in which music video content is presented, where the music video content includes an image 220, and the image 220 is associated with music content of the music video being played in the interface 200A.

As shown in FIG. 2A, description information such as a name and an author of the music is also presented in the interface 200A, and a dynamic effect associated with the music may also be presented in the interface 200A. For example, the image 220 or lyrics presented in the interface 200A may move up and down with the rhythm or beat of the music to present a dynamic effect consistent with an audio feature of the music.

In some embodiments, a control 210 may also be presented in the interface 200A. The electronic device 110 may obtain a generation request in response to the control 210 being triggered, where the generation request is associated with reference music. For example, in response to the control 210 being triggered, the electronic device 110 may present a selection interface of the reference music, where the reference music includes music for generating a music video.

In some embodiments, the reference music includes: uploaded first music and/or second music selected from a set of candidate music and/or third music determined based on query information and/or fourth music generated based on generation parameters.

In some examples, the first music may include music uploaded by a current user or an another user. The second music may include music selected by the current user from a set of music stored in the electronic device 110, or the second music may also include a set of available music obtained from the server. The third music may include music presented based on query information input by the user. For example, the user may specify information such as a type, a length, and an author of music to search for the third music from available music. The fourth music may include music generated based on some parameters. For example, the electronic device 110 may generate the fourth music based on some user input, such as music beats and music styles. The generated fourth music may be further used as reference music to generate a corresponding music video.

In some embodiments, after determining the reference music, the electronic device 110 may obtain a generation request, the generation request is associated with the reference music. For example, the generation request may be associated with the reference music. For example, the generation request may include some parameters that indicate some attributes and features of the reference music. For example, these parameters may indicate a duration, a type, lyrics content, etc., of the reference music.

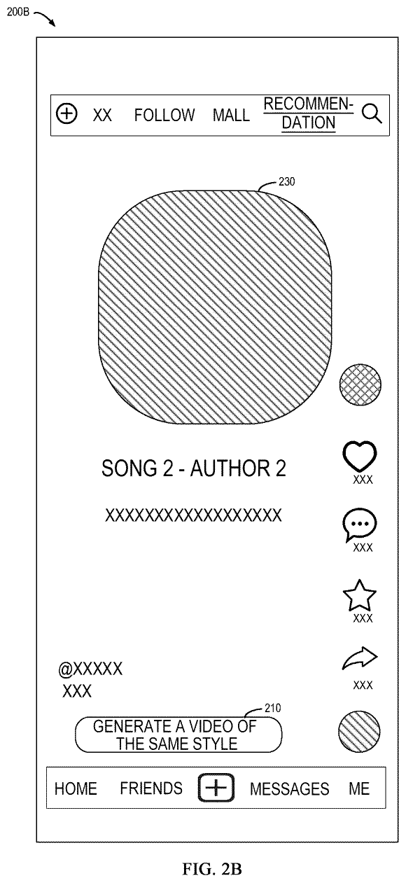

In some embodiments, the electronic device 110 may provide a music video generated based on the generation request. For example, the electronic device 110 may generate a corresponding music video in response to receiving the generation request. In some other examples, the electronic device 110 may initiate a generation process of a music video in response to receiving the generation request. The generation process is described in detail in FIG. 3 and will not be repeated here.

In some embodiments, the music video is generated based on a video template and a set of images. The video template may include, for example, a dynamic effect of the video. The set of images may be generated by a machine learning model. Here, the machine learning model may include any machine learning model capable of generating image content, and the present disclosure is not limited here.

In some embodiments, the video template is determined based on the audio feature of the reference music. For example, the audio feature may include a rhythm of the audio, a length of the audio, a timbre of an instrument in the audio, etc. The electronic device 110 may generate the video template matching the music based on these features.

In some embodiments, the audio feature is determined based on the following process: determining rhythm information of the reference music, and determining the audio feature of the reference music based on the rhythm information. For example, the electronic device 110 may determine the rhythm information (e.g., the number of beats per minute, the changes of the audio beat, etc.) of the reference music. After that, the electronic device 110 may determine the audio feature of the reference music based on the rhythm information.

In some embodiments, the video template is generated based on the following process: generating a set of dynamic effects matching the rhythm information; and generating the video template based on the set of dynamic effects. For example, the electronic device 110 may generate a set of dynamic effects matching the number of beats per minute of the music, the set of dynamic effects including lyrics that move up and down with the beats of the music, a set of images that rotate according to the rhythm, or interface icons that move according to the rhythm. Moreover, the electronic device 110 may further generate the video template based on the set of dynamic effects, and the video template may be applied to the music video.

In some embodiments, at least one dynamic effect in the set of dynamic effects is applied to lyrics content of the reference music. For example, the lyrics content presented in the interface may rhythm with the music.

In some embodiments, the set of images is generated based on the description information of the reference music. The description of the description information of the set of images and the reference music will be specifically described below with reference to FIG. 3, and will not be repeated here.

Referring to FIG. 2B, FIG. 2B shows an interface 200B in which another music video may be presented, and the another music video may be generated with reference to attributes of the music video shown in FIG. 2A.

In some embodiments, the electronic device 110 may generate a generation request associated with a reference video in response to an operation for the control 210, and generate a corresponding music video based on the generation request.

In some embodiments, the generation request is also associated with a reference video, and the music video is also generated based on at least one attribute of the reference video. For example, the reference video may include the music video shown in the interface 200A, and the music video shown in the interface 200B may be associated with a parameter of the reference video.

In some embodiments, the at least one attribute includes at least one of: a background style of the reference video, a video template associated with the reference video, and a content layout of the reference video. For example, the background style of the music video shown in the interface 200B may be the same or similar to the background style of the music video shown in the interface 200A.

In some embodiments, the video template of the music video in the interface 200B is the same or similar to the video template of the music video in the interface 200A, for example, both of them have similar dynamic effects or a set of image content of a similar style.

In addition, the content layout of the music video in the interface 200B may be the same or similar to the content layout of the music video in the interface 200A. For example, the position of an image 230 in the interface 200B is close to the position of the image 220 in the interface 200A.

Referring to FIG. 3, FIG. 3 shows an example block diagram 300 of a music video generation method according to some embodiments of the present disclosure.

As shown in FIG. 3, at a block 302, the electronic device 110 may receive an audio file, which may be selected by a user or generated by the electronic device 110. For example, the audio file here may include an audio file uploaded by a current user or an another user, and may also include an audio file selected by the current user from a set of audio files stored in the electronic device 110. The audio file may also be an available audio file obtained from the server.

In addition, the audio file may include an audio file presented based on query information input by the user. For example, the user may specify information such as a type, a length, and an author of music to select an audio file for which video generation needs to be performed from a set of files. The music in the audio file may include music generated based on some parameters. For example, the electronic device 110 may generate the audio file based on some user input, such as parameters of music beats and music styles.

At a block 306, the electronic device 110 may extract audio information. The audio information here may include attributes and features of the music stored in the audio file. For example, the electronic device 110 may extract an accompaniment instrument in the music and determine the attributes and features of the music according to the accompaniment instrument. The electronic device 110 may also extract, for example, an audio beat rate in the audio file. The above audio information may be used as a material for a video dynamic effect template in a subsequent generation step. For example, the electronic device 110 may select an appropriate dynamic effect to display in the music video based on the accompaniment instrument of the music. For example, if the accompaniment instrument of the music includes a drum instrument, the electronic device 110 may add a rippled dynamic effect to the video dynamic effect template to match the drumbeat in the music, thereby increasing the interest of the music video.

At a block 310, the electronic device 110 may obtain a beat rate of the music. Here, the beat rate is only used as an example of the subsequent generation process, and the electronic device 110 may also generate a subsequent dynamic effect template based on other music information, such as the accompaniment instrument type mentioned above. In addition, in some other embodiments, the electronic device 110 may also use various audio information to assist in the generation of the video dynamic effect template. For example, the electronic device 110 may automatically select a corresponding dynamic effect template based on the beat rate and the accompaniment instrument type. The dynamic effect template may be pre-configured by a developer or manually adjusted by a user. Secondly, the dynamic effect template may also be selected based on information provided by the server. For example, a dynamic effect template with a high frequency of use may be preferentially selected by the electronic device 110.

At a block 314, the electronic device 110 may generate a video dynamic effect template based on the beat rate obtained at the block 310. Here, the generation of the dynamic effect template may be based on a preset configuration of the video application, which may be configured by a developer. In addition, in order to save computing resources of the electronic device 110, the electronic device 110 may also send a template generation request to the server or cloud, and the electronic device 110 may also use some machine learning models to generate the template.

At a block 318, the electronic device 110 may generate a dynamic effect of the music video based on the video dynamic effect template generated at the block 314, and the dynamic effect of the music video matches the rhythm of the music. As some non-limited examples, the dynamic effect of the music video may include, for example, a ripple dynamic effect, and a movement frequency of the ripple dynamic effect may match the number of beats of the music. For example, if the number of beats per minute of the music is 120 beats per minute, the electronic device 110 may present a ripple dynamic effect with a frequency of 120 Hz in the interface. The dynamic effect may bring users a visual experience similar to a metronome, thereby increasing the interest of the music video.

At a block 304, the electronic device 110 may obtain music information (e.g., song information, i.e., the description information mentioned above) of the music. The information may be input by the user, or the information may also be extracted by the electronic device 110 based on the selected music. Here, the process of extracting the music information may be completed by the electronic device 110 alone (i.e., without relying on online resources). However, in some other embodiments, the extraction process of the music information may be assisted by the server. For example, the server may transmit information about the music return. For example, the server may determine an author of the music and a release date of the music according to a file name of the music.

At a block 308, in some embodiments, the electronic device 110 may construct a prompt based on the description information. For example, the electronic device 110 may generate a required prompt based on the description information via prompt engineering, and the prompt may be used to generate a set of images, which may be, for example, the image 220 in the interface 200A. Here, the set of images includes pictures and videos, which will be presented in the music video to provide users with a richer visual experience.

At a block 312, the electronic device 110 may obtain a standardized prompt via the above prompt engineering. In some embodiments, the electronic device 110 may construct the prompt based on the description information and a preset prompt template. The preset prompt template may be preset by a developer. The prompt here may be constructed in the form of a natural language, for example, “Song name: ABCD; author: EFG; genre: rock; output images: 3 pictures; image content: rock band”. These prompts may be presented in the interface of the electronic device 110 and may be adjusted by the user so that the generated images better meet the requirements of the user.

At a block 316, the electronic device 110 may provide the prompt to an image generation model to generate the set of images. The image generation model may include, for example, a pre-trained large model. The set of images may include a set of pictures or a set of videos. The set of images may have a logical association. For example, a set of pictures may present a complete story or plot, which may correspond to the music content of the reference music. Through the above process, the electronic device 110 may present images that better match the music content, thereby increasing the attractiveness of the music content.

At a block 320, the electronic device 110 may obtain the generated set of images. The set of images may be presented, for example, as part of the picture of the music video in the interface of the electronic device 110. For example, the set of images may be presented at the position of the image 220 in the interface 200A. In addition, in some other embodiments, the presentation position of the set of images in the video may be changed. For example, the position of the set of images may move up and down in the music video to match the rhythm of the music, or it may move in the interface to present a special dynamic effect according to the preset configuration.

At a block 322, in some embodiments, the electronic device 110 may determine a background style of the music video based on the set of images. For example, the electronic device 110 may extract a core color, or a color occupying a largest portion, or a main color of the pictures or videos based on the set of images to use as a background color of the music video. In addition to the background color, the background style of the music video may further include a background pattern of the music video, etc.

At a block 324, the electronic device 110 may generate a theme color of the music video based on colors of the extracted set of images. The theme color may be applied to the music video. For example, if the content of the generated set of images is about the sea, the electronic device 110 may extract blue as the theme color of the video, and the electronic device 110 may add a change effect of color saturation to the theme color as one of the dynamic effects of the music video.

At a block 326, the electronic device 110 may concatenate or combine the above video elements. That is, the electronic device 110 may combine the video dynamic effect, the set of images in the music video, and the theme color of the music video to generate a complete music video.

At a block 328, the electronic device 110 may provide the generated music video. For example, the electronic device 110 may directly present the generated music video in the interface, or the electronic device 110 may also save the generated music video as a video file in a memory of the electronic device 110. In addition, the electronic device 110 may also directly post the music video to a video platform for other users to watch.

In some embodiments, similar to that shown in the interface 200A and the interface 200B, the electronic device 110 may further generate another music video based on the music video generated at the block 328. For example, the music video generated at the block 328 may include a music video A, and the electronic device 110 may generate a music video B with a similar video style or video parameters as the music video A in response to a user operation (e.g., triggering the control 210). The music video B may have, for example, a similar theme color as the music video A, a set of images with a similar theme, or a similar set of dynamic effects. The above generation process of a music video may improve the efficiency of music video generation and reduce the amount of operations required by users when generating music videos.

In this way, through generating a music video based on an audio feature of music and a video template, embodiments of the present disclosure are capable of efficiently generating music videos based on features of music and video templates, thereby improving the efficiency of music video generation, increasing the fit between music videos and music, and enriching the content of music videos.

In addition, through the above automatic generation process of music videos, embodiments of the present disclosure are capable of efficiently and conveniently generating music videos matching the music.

### Example Process

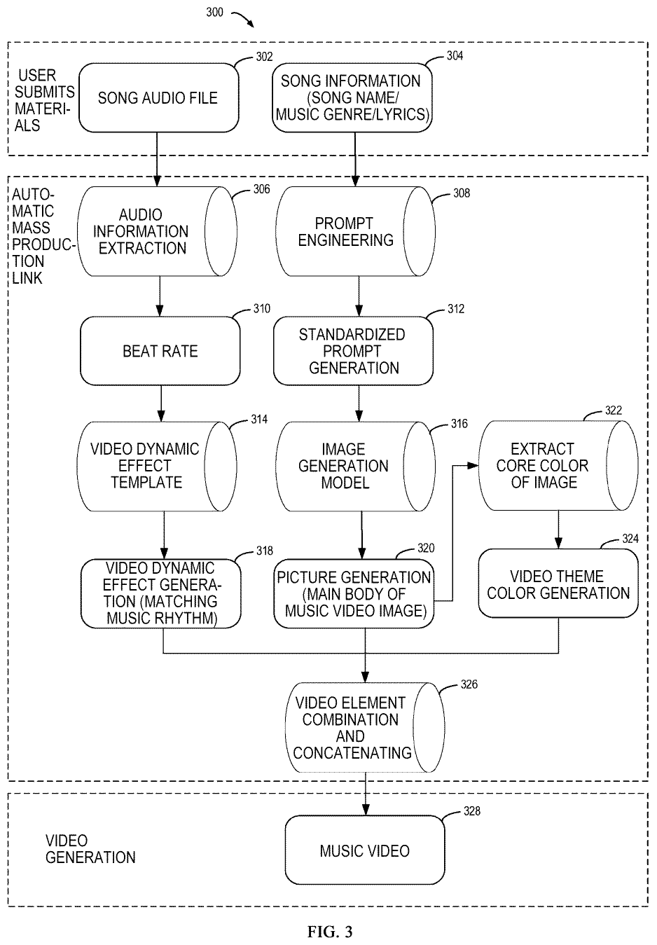

FIG. 4 shows a flowchart of an example process 400 of music video generation according to some embodiments of the present disclosure. The process 400 may be implemented at the electronic device 110. The process 400 is described below with reference to FIG. 1.

As shown in FIG. 4, at a block 410, the electronic device 110 obtains a generation request, the generation request being associated with reference music.

At a block 420, the electronic device 110 provides a music video generated based on the generation request, where the music video is generated based on a video template and a set of images, the video template is determined based on an audio feature of the reference music, and the set of images is generated based on description information of the reference music.

In some embodiments, the audio feature is determined based on the following process: determining rhythm information of the reference music; and determining the audio feature of the reference music based on the rhythm information.

In some embodiments, the video template is generated based on the following process: generating a set of dynamic effects matching the rhythm information; and generating the video template based on the set of dynamic effects.

In some embodiments, at least one dynamic effect in the set of dynamic effects is applied to lyrics content of the reference music.

In some embodiments, the set of images is generated based on the following process: constructing a prompt based on the description information; and providing the prompt to an image generation model to generate the set of images.

In some embodiments, constructing the prompt based on the description information includes: constructing the prompt based on the description information and a preset prompt template.

In some embodiments, a background style of the music video is determined based on the set of images.

In some embodiments, the generation request is further associated with a reference video, and the music video is further generated based on at least one attribute of the reference video.

In some embodiments, the at least one attribute comprises at least one of the following: a background style of the reference video, a video template associated with the reference video, and a content layout of the reference video.

In some embodiments, the reference music comprises at least one of the following: uploaded first music, second music selected from a set of candidate music, third music determined based on query information, and fourth music generated based on generation parameters.

### Example Apparatus and Device

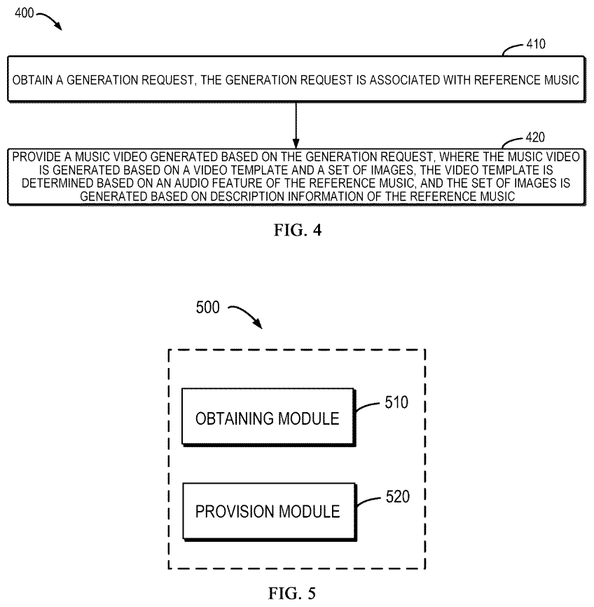

Embodiments of the present disclosure further provide a corresponding apparatus for implementing the above method or process. FIG. 5 shows a schematic structural block diagram of an example apparatus 500 for music video generation according to some embodiments of the present disclosure. The apparatus 500 may be implemented as or included in the electronic device 110. Each module/component in the apparatus 500 may be implemented by hardware, software, firmware, or any combination thereof.

As shown in FIG. 5, the apparatus 500 includes: an obtaining module 510 configured to obtain a generation request, the generation request being associated with reference music; and a provision module 520 configured to provide a music video generated based on the generation request, wherein the music video is generated based on a video template and a set of images, the video template is determined based on an audio feature of the reference music, and the set of images is generated based on description information of the reference music.

In some embodiments, the apparatus 500 further includes a rhythm information determination module configured to determine rhythm information of the reference music; and determine the audio feature of the reference music based on the rhythm information.

In some embodiments, the apparatus 500 further includes a dynamic effect generation module configured to generate a set of dynamic effects matching the rhythm information; and generate the video template based on the set of dynamic effects.

In some embodiments, at least one dynamic effect in the set of dynamic effects is applied to lyrics content of the reference music.

In some embodiments, the apparatus 500 further includes a prompt construction module configured to construct a prompt based on the description information; and provide the prompt to an image generation model to generate the set of images.

In some embodiments, the prompt construction module is further configured to construct the prompt based on the description information and a preset prompt template.

In some embodiments, a background style of the music video is determined based on the set of images.

In some embodiments, the generation request is also associated with a reference video, and the music video is also generated based on at least one attribute of the reference video.

In some embodiments, the at least one attribute includes at least one of the following: a background style of the reference video, a video template associated with the reference video, and a content layout of the reference video.

In some embodiments, the reference music includes at least one of the following: uploaded first music, second music selected from a set of candidate music, third music determined based on query information, and fourth music generated based on generation parameters.

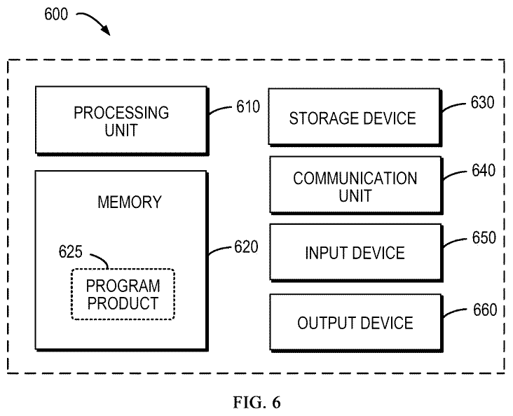

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and may execute various processes based on the programs stored in the memory 620. In a multi-processor system, multiple processing units execute computer executable instructions in parallel to improve the parallel processing capability of the electronic device 600.

The electronic device 600 typically includes multiple computer storage medium. Such medium may be any available medium accessible by the electronic device 600, including, but not limited to, volatile and non-volatile medium, removable and non-removable medium. The memory 620 may be a volatile memory (e.g., a register, cache, a random access memory (RAM)), a non-volatile memory (such as a read-only memory (ROM), an electrically erasable programmable read-only memory (EEPROM), a flash memory), or any combination thereof. The storage device 630 may be a removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, a disk driver for reading from or writing to a removable, non-volatile disk (e.g., a “floppy disk”), and an optical disk driver for reading from or writing to a removable, non-volatile optical disk may be provided. In these cases, each driver may be connected to the bus (not shown) by one or more data medium interfaces. The memory 620 may include a computer program product 625 having one or more program modules configured to perform various methods or acts of the various embodiments of the present disclosure.

The communication unit 640 implements communication with other electronic devices through the communication medium. Additionally, the functions of the components of the electronic device 600 may be implemented by a single computing cluster or multiple computing machines, which may communicate through communication connections. Therefore, the electronic device 600 may use a logical connection with one or more other servers, a network personal computer (PC), or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) such as a storage device and a display device, with one or more devices enabling the user to interact with the electronic device 600, or with any devices (e.g., a network card, a modem, etc.) enabling the electronic device 600 to communicate with one or more other electronic devices through the communication unit 640 as needed. Such communication may be performed via input/output (I/O) interfaces (not shown).

According to an example implementation of the present disclosure, a computer-readable storage medium is provided, on which computer executable instructions are stored, where the computer executable instructions are executed by a processor to implement the method described above. According to an example implementation of the present disclosure, there is further provided a computer program product, the computer program product is tangibly stored on a non-transitory computer-readable medium and includes computer executable instructions, and the computer executable instructions are executed by a processor to implement the method described above.

Various aspects of the present disclosure are described herein with reference to flowcharts and/or block diagrams of the method, the apparatus, the device, and the computer program product implemented according to the present disclosure. It should be understood that each block of the flowcharts and/or block diagrams, and combinations of the blocks in the flowcharts and/or block diagrams, may be implemented by computer-readable program instructions.

These computer-readable program instructions may be provided to the processing unit of a general-purpose computer, a special-purpose computer, or other programmable data processing apparatus to produce a machine, such that when these instructions are executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, these instructions cause the computer, the programmable data processing apparatus, and/or other devices to work in a specific manner, and accordingly, the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or other devices, such that a series of operation steps are performed on the computer, the other programmable data processing apparatus, or the other devices to generate a computer-implemented process, so that the instructions executed on the computer, the other programmable data processing apparatus, or the other devices implement the functions/actions specified in one or more blocks of the flowcharts and/or block diagrams.

The flowcharts and block diagrams in the drawings show the possibly implemented architectures, functions, and operations of the system, the method, and the computer program product according to multiple implementations of the present disclosure. In this regard, each block in the flowchart or block diagram may represent a module, a program segment, or a part of instructions, and the module, the program segment, or the part of instructions contains one or more executable instructions for implementing the specified logical functions. In some alternative implementations, the functions marked in the blocks may also occur in an order different from that marked in the drawings. For example, two consecutive blocks may actually be executed substantially in parallel, or they may sometimes be executed in the reverse order, depending on the functions involved. It should also be noted that each block in the block diagrams and/or flowcharts, and combinations of the blocks in the block diagrams and/or flowcharts, may be implemented by a special-purpose hardware-based system that executes specified functions or actions, or may be implemented by a combination of special-purpose hardware and computer instructions.

The implementations of the present disclosure have been described above, and the above description is illustrative, non-exhaustive, and not limited to the disclosed implementations. Without departing from the scope and spirit of the illustrated implementations, many modifications and changes will be apparent to those of ordinary skill in the art. The terms used herein are selected to best explain the principles of the implementations, the actual applications or improvements to the technologies in the market, or to enable other those of ordinary skill in the art to understand the implementations disclosed herein.

1. A method for music video generation, comprising:
obtaining a generation request, the generation request being associated with reference music; and
providing a music video generated based on the generation request, wherein the music video is generated based on a video template and a set of images, the video template is determined based on an audio feature of the reference music, and the set of images is generated based on description information of the reference music.

2. The method of claim 1, wherein the audio feature is determined based on the following process:
determining rhythm information of the reference music; and
determining the audio feature of the reference music based on the rhythm information.

3. The method of claim 2, wherein the video template is generated based on the following process:
generating a set of dynamic effects matching the rhythm information; and
generating the video template based on the set of dynamic effects.

4. The method of claim 3, wherein at least one dynamic effect in the set of dynamic effects is applied to lyrics content of the reference music.

5. The method of claim 1, wherein the set of images is generated based on the following process:
constructing a prompt based on the description information; and
providing the prompt to an image generation model to generate the set of images.

6. The method of claim 5, wherein constructing the prompt based on the description information comprises:
constructing the prompt based on the description information and a preset prompt template.

7. The method of claim 1, wherein a background style of the music video is determined based on the set of images.

8. The method of claim 1, wherein the generation request is further associated with a reference video, and the music video is further generated based on at least one attribute of the reference video.

9. The method of claim 8, wherein the at least one attribute comprises at least one of the following:
a background style of the reference video,
a video template associated with the reference video, and
a content layout of the reference video.

10. The method of claim 1, wherein the reference music comprises at least one of the following:
uploaded first music,
second music selected from a set of candidate music,
third music determined based on query information, and
fourth music generated based on generation parameters.

11. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
obtaining a generation request, the generation request being associated with reference music; and
providing a music video generated based on the generation request, wherein the music video is generated based on a video template and a set of images, the video template is determined based on an audio feature of the reference music, and the set of images is generated based on description information of the reference music.

12. The electronic device of claim 11, wherein the audio feature is determined based on the following process:
determining rhythm information of the reference music; and
determining the audio feature of the reference music based on the rhythm information.

13. The electronic device of claim 12, wherein the video template is generated based on the following process:
generating a set of dynamic effects matching the rhythm information; and
generating the video template based on the set of dynamic effects.

14. The electronic device of claim 13, wherein at least one dynamic effect in the set of dynamic effects is applied to lyrics content of the reference music.

15. The electronic device of claim 11, wherein the set of images is generated based on the following process:
constructing a prompt based on the description information; and
providing the prompt to an image generation model to generate the set of images.

16. The electronic device of claim 15, wherein constructing the prompt based on the description information comprises:
constructing the prompt based on the description information and a preset prompt template.

17. The electronic device of claim 11, wherein a background style of the music video is determined based on the set of images.

18. The electronic device of claim 11, wherein the generation request is further associated with a reference video, and the music video is further generated based on at least one attribute of the reference video.

19. The electronic device of claim 18, wherein the at least one attribute comprises at least one of the following:
a background style of the reference video,
a video template associated with the reference video, and
a content layout of the reference video.

20. A non-transitory computer-readable storage medium having a computer program stored thereon, the computer program being executable by a processor to implement acts comprising:
obtaining a generation request, the generation request being associated with reference music; and
providing a music video generated based on the generation request, wherein the music video is generated based on a video template and a set of images, the video template is determined based on an audio feature of the reference music, and the set of images is generated based on description information of the reference music.
